(19) United States
(12) Patent Application Publication
(10) Pub. No.: US 2005/0251823 A1
(43) Pub. Date: Nov. 10, 2005

(54) Coordinated cross media service

(75) Inventor: Ilari Saarikivi, Salo (FI)

Correspondence Address: BANNER & WITCOFF, 1001 G STREET N W, SUITE 1100, WASHINGTON, DC, 20001, US

(73) Assignee: Nokia Corporation, Espoo (FI)

(21) Appl. No.: 10/839,578

(22) Filed: May 5, 2004

(51) Int. Cl. H04N 7/173; H04N 7/16; G06F 13/00; H04N 5/445; G06F 3/00; H04N 5/44

(52) U.S. Cl. 725/42; 725/135; 725/136; 725/39; 348/734

(57) ABSTRACT

The invention provides coordinated cross media services to users. Supplemental information is provided to multiple cross media devices in order to enhance a user's interaction with a coordinated cross media service.

### FIELD OF THE INVENTION

Aspects of the present invention relate generally to providing coordinated cross media services to users. More specifically, aspects of the present invention provide supplemental information to multiple cross media devices in order to enhance a user's interaction with a coordinated cross media service.

### BACKGROUND OF THE INVENTION

Cross media services include services which enable users to interact with television programs through devices such as cellular phones. The interaction enhances a user's viewing experience by enabling a user to purchase merchandise, request additional information on a subject matter, or participate by voting on an issue.

One drawback of current cross media services is that users have found it difficult to make full use of the interactive process on their mobile phone while trying to concentrate on a television program. Users have to focus on their cellular phones to view the supplemental information associated with the television program as the information about the possibilities offered by the interactive application at any specific moment of time is not displayed on the television screen. Therefore, users have to constantly share their attention between the television screen to view the television program and the cellular phone to view the supplemental information which takes away from a user's overall television viewing experience.

For example, FIG. 1 illustrates the current state of the art and the drawbacks just discussed. In FIG. 1, television program 102 is displayed on television set 104. The television set 104 may receive signals in a variety of ways such as satellite, cable, or broadcast through a network 106 and a first communication path 107. Television set 104 may be capable of viewing satellite and cable programming. A set-top box (STB) 108 for receiving signals from a satellite or cable provider may also be utilized with television set 104. The set-top box 108 may also be utilized to access the Internet.

A user terminal 110 such as a cellular phone may communicate to a cross media application server 112 via a two-way second communication path 113 and a mobile network 114. The cross media application server 112 provides supplemental information 116 pertaining to the television program 102 being viewed on television set 104. For example, supplemental information 116 may include information regarding the purchasing of a compact disc (CD), the music videos for the songs on the compact disc being displayed on television set 104. As discussed above, users watching television program 102 on television set 104 have to focus on user terminal 110 to view the supplemental information 116 transmitted by the cross media application server 112. This constant sharing of a user's attention between television set 104 and user terminal 110 takes away from the user's overall cross media experience.

Therefore, there exists a need in the art, for a method and system that addresses the drawbacks of the existing cross media services and efficiently enhances a user's viewing experience by providing supplemental information substantially simultaneously to multiple devices used in cross media service.

### SUMMARY OF THE INVENTION

Aspects of the present invention address the drawbacks mentioned above, by providing coordinated cross media services to a user. The methods and systems of the current invention provide supplemental information that is transmitted to a user terminal substantially simultaneously with the supplemental information being transmitted to a television receiver. The transmitted supplemental information may be displayed on both a television set and a user terminal, thereby improving a user's cross media experience.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 shows a prior art configuration for cross media services;

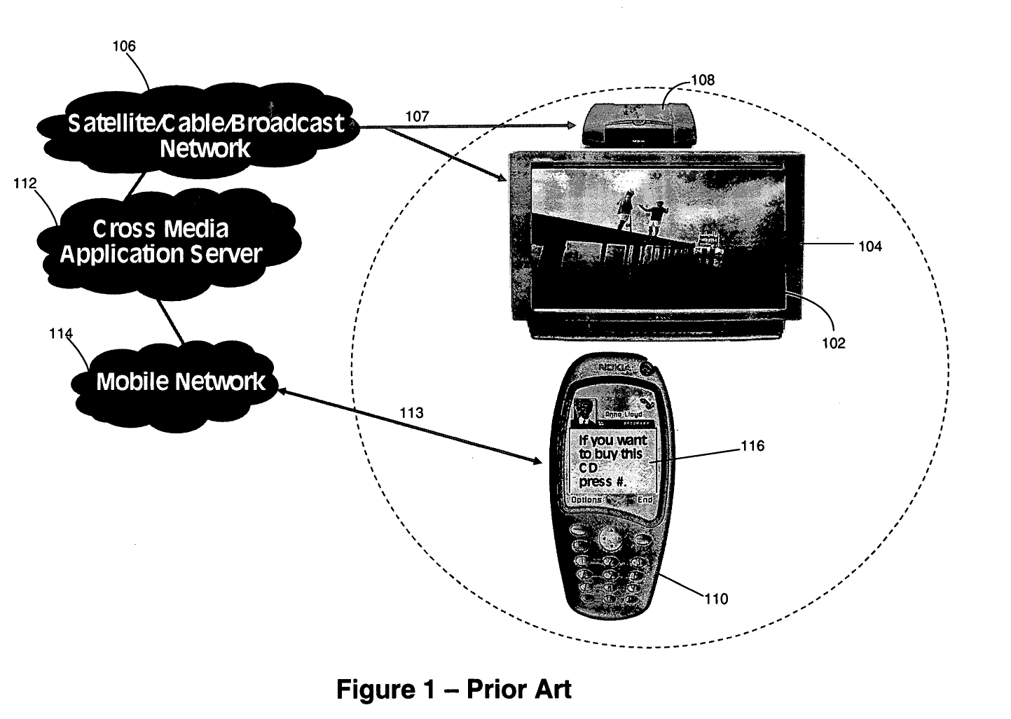

FIG. 2 shows a configuration for coordinated cross media services in accordance with an aspect of the invention;

FIG. 3 illustrates a flow diagram for displaying supplemental information on a television set for use in coordinated cross media services in accordance with an aspect of the invention;

FIG. 4 illustrates an alternative flow diagram for displaying supplemental information with the use of a receiving code on a television set for use in coordinated cross media services in accordance with an aspect of the invention;

FIG. 5 shows another configuration for coordinated cross media services in accordance with another aspect of the invention;

FIG. 6 illustrates a flow diagram in accordance with the configuration shown in FIG. 5 for displaying supplemental information in coordinated cross media services in accordance with an aspect of the invention;

FIG. 7 shows yet another configuration for coordinated cross media services in accordance with an aspect of the invention; and

FIG. 8 illustrates a flow diagram in accordance with the configuration shown in FIG. 7 for displaying supplemental information in coordinated cross media services in accordance with an aspect of the invention.

### DETAILED DESCRIPTION

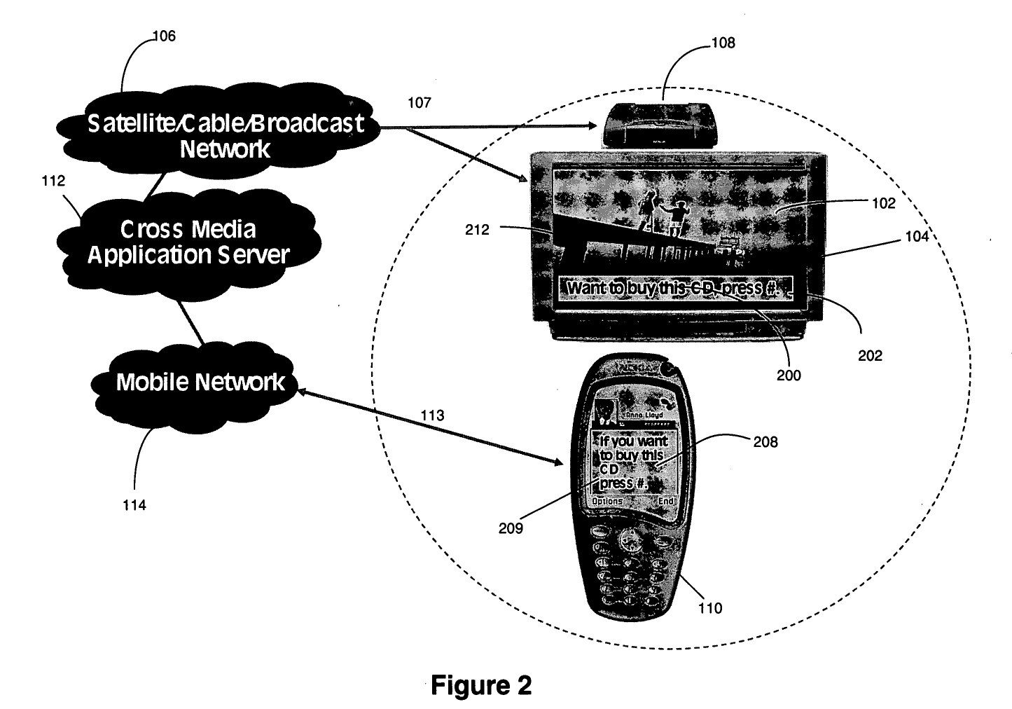

FIG. 2 shows a configuration for coordinated cross media services in accordance with an aspect of the invention. It will be appreciated by those skilled in the art that the present invention is applicable to enhancing a user's experience with a variety of media content used in cross media services such as television programs, radio, movies, or other forms of media. The cross media content may be used to provide supplemental information, prompts or to enable interactivity like voting or shopping.

As shown in FIG. 2, a television program 102 is displayed on television set 104. The television set 104 may receive signals from a variety of sources such as satellite, cable, or broadcast. The signals may be passed through a network 106 and a first communication path 107. The first communication path 107 may comprise a terrestrial television broadcast, a cable television network or satellite television broadcast. Television set 104 may include the capability of directly receiving signals from satellite, cable or terrestrial providers. Alternatively, a set-top box 108 may be utilized for receiving signals from a satellite, terrestrial or cable providers. The set-top box 108 or the television set 104 may also include the capability of accessing the Internet.

Cross media application server 112 may receive television programming and related cross media services which will be forwarded by cross media application server 112 to television set 104. Alternatively, the cross media application server 112 may receive only the cross media services which will be forwarded by cross media application server 112 to television set 104. In this case, the television programming may be forwarded directly by a transmission or broadcasting network. A user terminal 110 may be used to communicate with cross media application server 112. User terminal 110 may comprise a wireless communication device, such as a cellular phone or a personal data assistant (PDA), or a laptop computer. A user may register with cross media application server 112 using user terminal 110. Cross media application sever may contain databases for storing user account information and registration information. Further cross media application server may contain a TV/STB transmission application and/or device that forwards programs to TV/STB receivers, a prompt application and/or device that forwards cross media services related to the forwarded programs to all or registered TV/STB receivers, a mobile client application and/or device that forwards cross media services related to transmitted programs to registered mobile terminals, a synchronization & timing application and/or device that forwards the programs and the cross media service in a predetermined manner, and an encryption application and/or device that creates an encryption code (or a receiving code). The encryption application encrypts the programs and may forward the encryption code to the television set 104 or set-top box 108 for decrypting first supplemental information 200.

User terminal 110 may communicate to cross media application server 112 via a two-way second communication path 113 and a mobile network 114. The two-way second communication path 113 may comprise a wireless cellular communication network, WLAN, Bluetooth or an Internet Protocol Datacasting (IPDC) broadcast. Those skilled in the art will realize that the two-way second communication path 113 may also comprise other telephone networks that may include PSTN, ISDN lines, or DSL lines.

Cross media application server 112 may transmit first supplemental information 200 pertaining to the television program 102 to television set 104. Television set 104 may display first supplemental information 200 in a message window 202 which may be displayed on a screen 212 of television set 104. The message window may be implemented as a PIP (picture-in-picture), mosaic representation, a separate window or superimposed into the television program. The message window 202 may be repositioned to various locations on screen 212 of television set 104 in order to reduce the amount of viewing obstruction to television program 102.

In addition, cross media application server 112 may also substantially simultaneously transmit second supplemental information 208 to user terminal 110. User terminal 110 may display second supplemental information 208 on a display screen 209 of user terminal 110. The second supplemental information may be implemented on the display screen as a PIP (picture-in-picture), mosaic representation, or a separate window.

For example, television set 104 may display a television program 102 comprising music videos corresponding to an artist's music on a particular compact disc. The particular compact disc containing the artist's music may be advertised for purchase by viewers of television program 102.

Cross media application server 112 may transmit first supplemental information 200 to television set 104 or set-top box 108 via a first communication path 107 and network 106. First supplemental information 200 may be displayed in a message window 202 on screen 212 of television set 104. First supplemental information may contain a statement such as “If you want to buy this CD press #.” As those skilled in the art will realize, first supplemental information 200 will be applicable to the television show 102 being presented to the user and is not limited to statements concerning the purchase of products.

Similarly, cross media application server 112 may substantially simultaneously transmit second supplemental information to user terminal 110 through a two-way second communication path 206 via a mobile network 114. Second supplemental information 208 may contain the exact same information as first supplemental information 200. For example, second supplemental information 208 may also contain a statement such as “If you want to buy this CD press #.” Alternatively, the first and second supplemental information transmitted substantially at the same time may be different, and they may supplement each other in order to accomplish a desired outcome. For example, the television set 104 may display a prompt “Check mobile device for the status of your request” and the user terminal 110 may display related information “Your request is validated and submitted.”

User terminal 110 may comprises a cellular phone and may display second supplemental information 209 on a display screen 209. A user watching television program 102 may be able to view the same supplemental information on both television set 104 and user terminal 110 enhancing a user's cross media experience as the user's attention may remain focused on the television program 102 and not be distracted by having to view the supplemental information displayed only on user terminal 110.

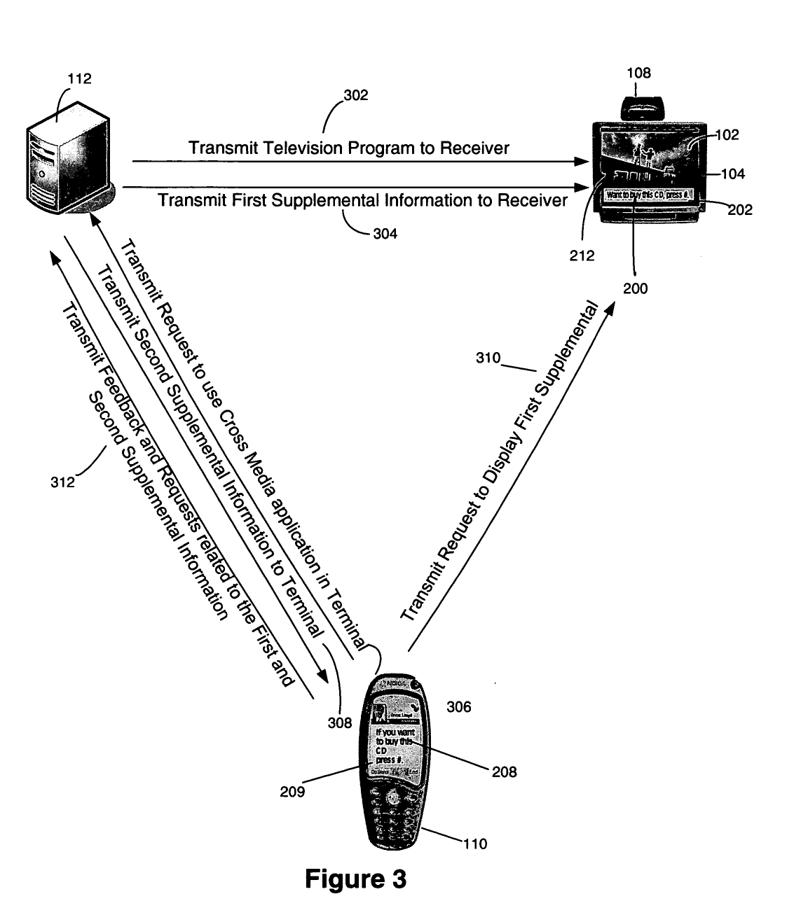

FIG. 3 illustrates a flow diagram for displaying supplemental information on a television set for use in coordinated cross media services. As shown in FIG. 3 at step 302, cross media application server 112 transmits a television program 102 to a receiver such as television set 104 or set-top box 108. Television set 104 may display the television program on screen 212.

In step 304, cross media application server 112 transmits first supplemental information 200 to television set 104 or set-top box 108. Cross media application server 112 synchronizes the transmission of the first supplemental information 200 and the television program 102. In addition, cross media application server 112 may substantially simultaneously transmit first and second supplemental information to the television set 104 or set-top box 108 and the user terminal 110. In an alternative aspect of the invention, cross media application server 112 may transmit television program 102 and first and second supplemental information in a predetermined synchronized manner. The first and second supplemental information may be synchronized or timed with the television program 102 so that they may be transmitted at substantially the same time. As an alterative, first and second supplemental information may be transmitted at a different time than television program 102 to give special effects to the communication.

First supplemental information 200 may be forwarded by an application program and/or device running on cross media application sever 112. The transmission of first supplemental information 200 may be over a first communication path 107. The Multimedia Home Platform (DVB-MHP) standard, or any other DVB or digital television broadcasting standard, may be utilized to generate transmission of first supplemental information 200 to television set 104 or set-top box 108. In addition, vertical blanking interval transmission, such as Teletext, Text-TV or Super Teletext services, may be used for transmitting first supplemental information 200. In this aspect of the invention, the first supplemental information 200 is transmitted over the network to all television receivers 104 in a coverage area of the transmission, i.e. the cross media application server 112 may not know or identify the receiving television or STB devices. A user of the television set 104 or STB receiver 108 may request the receiver to show the first supplemental information 200 transparently with the television program 102. A layout of the first supplemental information 200 may be especially designed to be displayed with the program so it does not disturb a user's watching experience. A request for displaying the first supplemental information 200 may be transmitted from the user terminal 110 or from a remote control device dedicated to the television receiver 104 or to the set-top box 108.

In step 306, user terminal 110 transmits a request to cross media application server 112 to use cross media services. This step may also include registering user terminal 110 with cross media application server 112.

Next, in step 308 cross media application server 112 transmits second supplemental information 208 to user terminal 110. The second supplemental information 208 may only be transmitted to those user terminals that have registered with cross media application server 112. User terminal 110 receives the second supplemental information 208 and may display the second supplemental information 208 on display screen 209. In step 310, user terminal 110 transmits a request to the television set 104 to display the first supplemental information on the television set 104. Television set 104 or set-top box 108 displays the first supplemental information 200. Finally, in step 312 user terminal 110 transmits feedback and requests related to the received information back to the cross media application server 112. Further, the cross media application server 112 may transmit the user's feedback or requests to a service provider for manipulation and utilization, such as to a product provider for a product delivery.

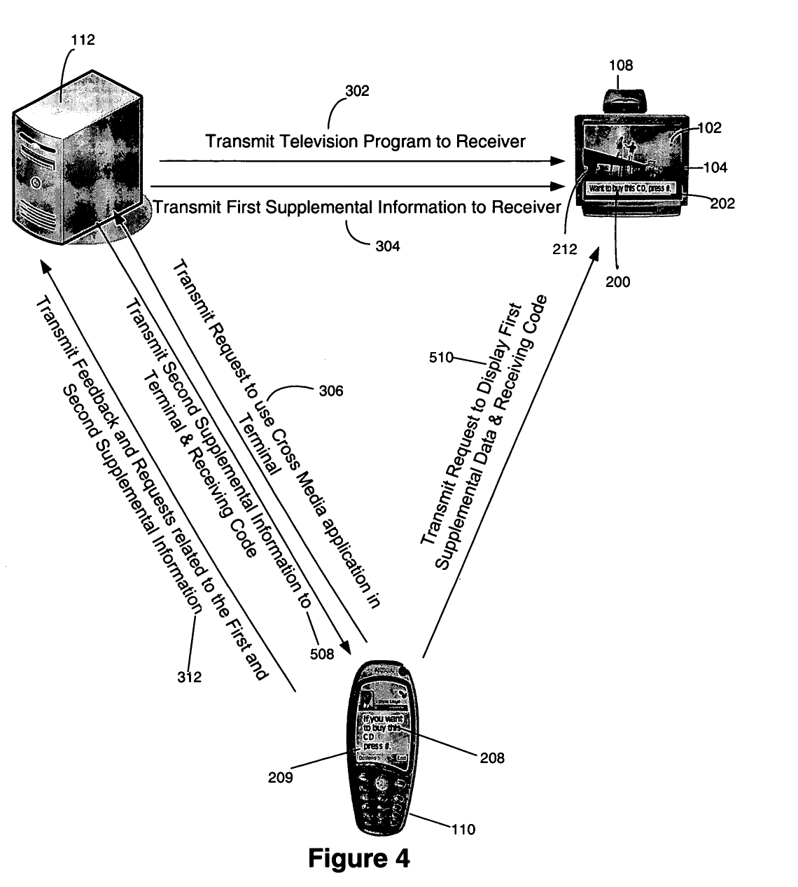

FIG. 4 illustrates an alternative flow diagram for displaying supplemental information, usually substantially simultaneously, on a user terminal and a television set. In this aspect of the invention, a receiving code, or an encryption code, related to the first supplemental information is utilized to encrypt and decrypt the first supplemental information that may be transmitted to a television set for use in coordinated cross media services. Some of the steps described with respect to FIG. 3 are also preformed in the embodiment of FIG. 4 and will not be repeated. Those same steps are indicated by use of the same numerals in both Figures for clarity.

Referring to step 508 of FIG. 4, cross media application server 112 transmits second supplemental information 208 and a receiving code (not shown) to user terminal 110. The second supplemental information 208 may only be transmitted to those user terminals that have registered with cross media application server 112. User terminal 110 receives the second supplemental information 208 and receiving code and may display the second supplemental information 208 on display screen 209. In step 510, user terminal 110 transmits a request to the television set 104 or set-top box 108 to display the first supplemental information on the television set 104. In addition, user terminal 110 forwards the receiving code to television set 104 or set-top box 108 for decryption of the first supplemental information 200 which may have been encrypted by cross media server 112 prior to transmission. The receiving code may be utilized so that only registered users may decode and display the first supplemental information 200 on the television set 104. Finally, in step 312 user terminal 110 transmits feedback and requests related to the received information which includes the first and second supplemental information back to the cross media application server 112.

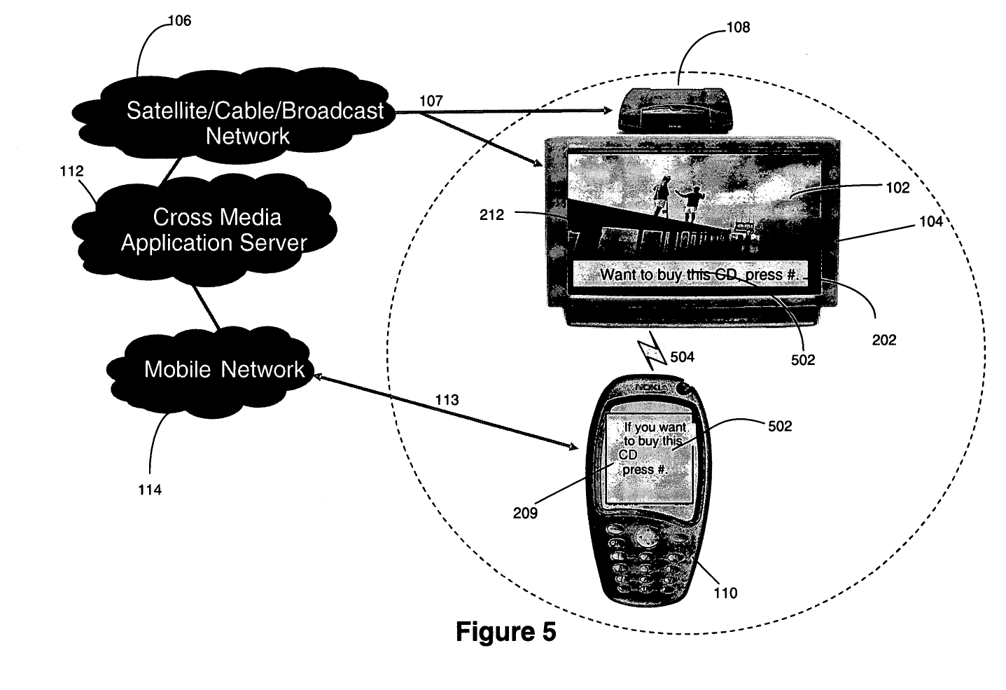

FIG. 5 shows another configuration for coordinated cross media services in accordance with another aspect of the invention. Features described in conjunction with FIGS. 2, 3 and 4 are also applicable with this aspect of the invention. Though not shown in FIG. 5, a user terminal and television receiver may be part of a single device such as IPDC terminal.

Referring to FIG. 5, a television program 102 is displayed on television set 104. The television set 104 may receive signals from a variety of sources such as satellite, cable, or broadcast. The signals may be passed through a network 106 and a first communication path 107. The first communication path 107 may comprise a terrestrial television broadcast, satellite television broadcast or a cable television network. Television set 104 may include the capability of directly receiving signals from satellite and cable providers. Alternatively, a set-top box 108 may be utilized for receiving signals from a satellite, terrestrial or cable provider. The set-top box 108 may also include the capability of accessing the Internet.

Cross media application server 112 may receive television programming which will be forwarded by cross media application server 112 to television set 104. A user terminal 110 may be used to communicate with cross media application server 112. User terminal 110 may comprise a cellular phone or other device such as a personal data assistant (PDA) or laptop computer. A user may register with cross media application server 112 using user terminal 110. Cross media application sever may contain databases for storing user account information and registration information.

User terminal 110 may communicate to cross media application server 112 via a two-way second communication path 113 and a mobile network 114. The two-way second communication path 113 may comprise a wireless cellular communication network or an Internet Protocol Datacasting (IPDC) broadcast. Those skilled in the art will realize that the two-way second communication path 113 may also comprise other telephone networks that may include PSTN, ISDN lines, or DSL lines.

Cross media application server 112 may transmit supplemental information 502 pertaining to the television program 102 to user terminal 110. User terminal 110 may display the supplemental information 502 on a display screen 209 of user terminal 110. User terminal 110 transmits the supplemental information 502 to television set 104 or set-top box 108 through a second communication path 504. The transmission of the supplemental information to the television set 104 may happen substantially simultaneously when receiving the supplemental information in the user terminal 110. The transmission may happen automatically when the cross media service is selected and activated. Alternatively, the transmission may be invoked manually by a request of the user. The request for the transmission may be originated from the television set 104, set-top box 108 or the user terminal 110. Alternatively, the transmission may happen automatically after a certain time interval. The second communication path 504 may comprise a short-range communication path such as Bluetooth, WLAN, WiFi, or IrDA.

Television set 104 may display supplemental information 502 in a message window 202 which may be displayed on a screen 212 of television set 104. The message window 202 may be repositioned to various locations on screen 212 of television set 104 in order to reduce the amount of viewing obstruction to television program 102. The supplemental information 502 on both television set 104 and user terminal 110 may be substantially simultaneously displayed in order to improve the cross media experience. A user's attention may remain focused on the television program 102 and not be distracted by having to view the supplemental information displayed only on user terminal 110.

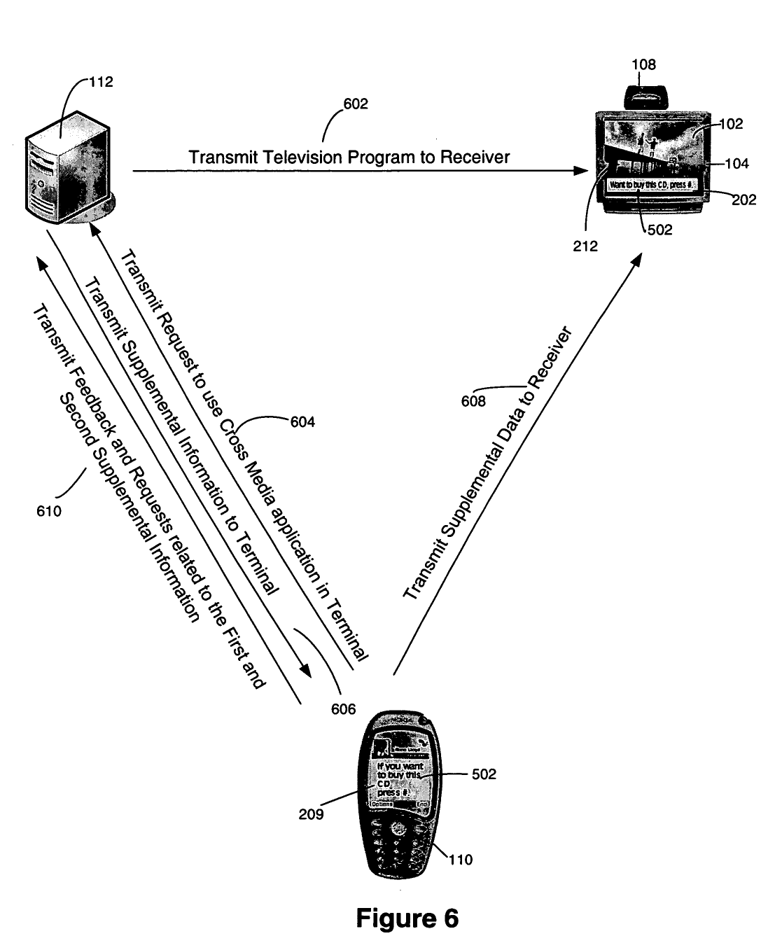

FIG. 6 illustrates a flow diagram in accordance with the configuration shown in FIG. 5 for displaying supplemental information in coordinated cross media services in accordance with an aspect of the invention. As shown in FIG. 6 at step 602, cross media application server 112 transmits a television program 102 to a receiver such as television set 104 or set-top box 108. Television set 104 may display the television program on screen 212. Features described in conjunction with FIGS. 2, 3 and 4 are also applicable to this aspect of the invention.

In step 604, user terminal 110 transmits a request to cross media application server 112 to use cross media services. This step may also include registering user terminal 110 with cross media application server 112.

Next, in step 606 cross media application server 112 transmits supplemental information 502 to user terminal 110. The information 502 may only be transmitted to those user terminals that have registered with cross media application server 112. User terminal 110 receives the supplemental information 502 and may display the supplemental information 502 on display screen 209. In step 608, user terminal 110 transmits supplemental information 502 to television set 104 or set-top box 108. Terminal 110 may transmit the supplemental information 502 over a second communication path 504 which may be short-range communication network such as Bluetooth. Finally, in step 610 user terminal 110 transmits feedback and requests related to the received information back to the cross media application server 112.

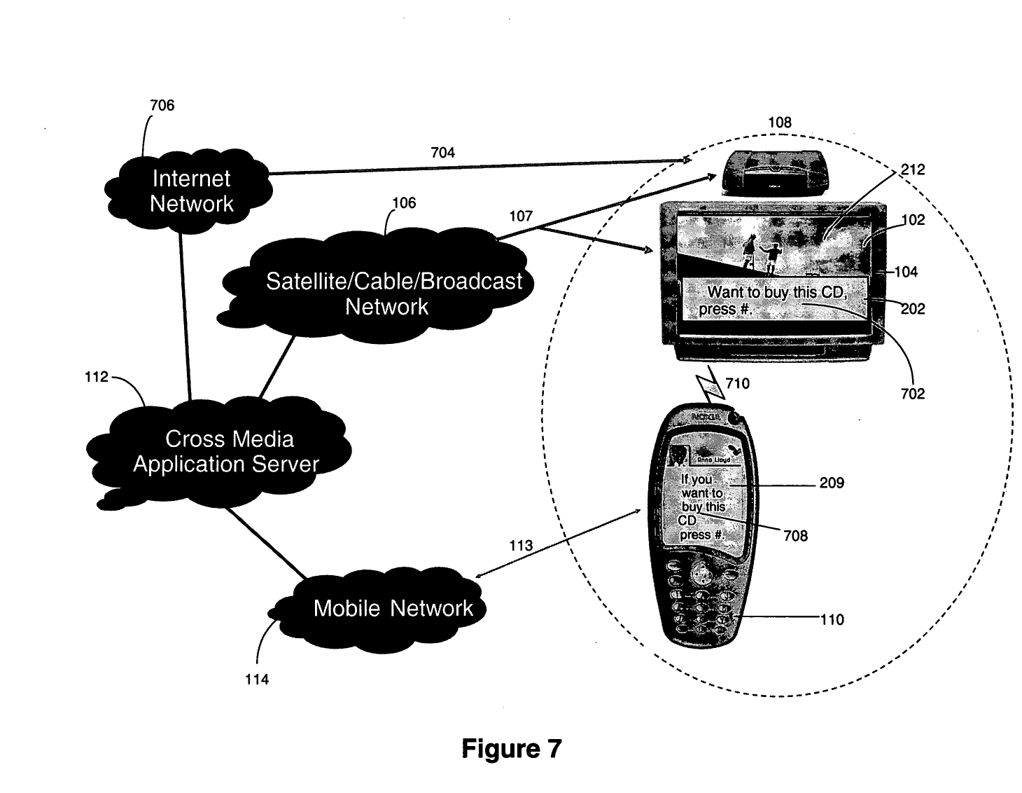

FIG. 7 shows yet another configuration for coordinated cross media services in accordance with an aspect of the invention. Features described in conjunction with FIGS. 2-6 are also applicable to this aspect of the invention. In FIG. 7, a television program 102 is displayed on television set 104. The television set 104 may receive signals from a variety of sources such as satellite, cable, or broadcast. The signals may be passed through a network 106 and a first communication path 107. The first communication path 107 may comprise a terrestrial television broadcast, a satellite television broadcast or a cable television network. Television set 104 may include the capability of directly receiving signals from terrestrial, satellite and cable providers. Alternatively, a set-top box 108 may be utilized for receiving signals from a terrestrial, a satellite or a cable provider. The set-top box 108 may also include the capability of accessing the Internet.

Cross media application server 112 may receive television programming which will be forwarded by cross media application server 112 to television set 104 or set-top box 108. A user terminal 110 may be used to communicate with cross media application server 112. User terminal 110 may comprise a cellular phone or other device such as a personal data assistant (PDA) or laptop computer. A user may register with cross media application server 112 using user terminal 110. Cross media application sever 112 may contain databases for storing user account information and registration information.

User terminal 110 may communicate with the television set 104 or set-top box 108 through a two-way fourth communication path 710 in order to request an address of the receiving television set 104 or set-top box 108. The two-way fourth communication path 710 may include a short-range communication path such as Bluetooth, WLAN, WiFi or IrDA. The address may include an IP-address, a URL, an email address or a telephone number.

User terminal 110 may communicate to cross media application server 112 via a two-way second communication path 113 and a mobile network 114. The two-way second communication path 113 may comprise a wireless cellular communication network or an Internet Protocol Datacasting (IPDC) broadcast. Those skilled in the art will realize that the two-way second communication path 113 may also comprise other telephone networks that may include PSTN, ISDN lines, or DSL lines.

Cross media application server 112 may transmit first supplemental information 702 pertaining to the television program 102 to television set 104 or set-top box 108 over a third communication path 704. The third communication path 704 may include a wireless or wireline communication network such as the Internet 706 or other wireless or wireline telecommunication network or broadcasting network.

Television set 104 may display first supplemental information 702 in a message window 202 which may be displayed on a screen 212 of television set 104. The message window 202 may be repositioned to various locations on screen 212 of television set 104 in order to reduce the amount of viewing obstruction to television program 102.

In addition, cross media application server 112 may also, usually substantially simultaneously, transmit second supplemental information 708 to user terminal 110. User terminal 110 may display second supplemental information 708 on a display screen 209 of user terminal 110. First supplemental information 702 may be identical information as second supplemental information 708.

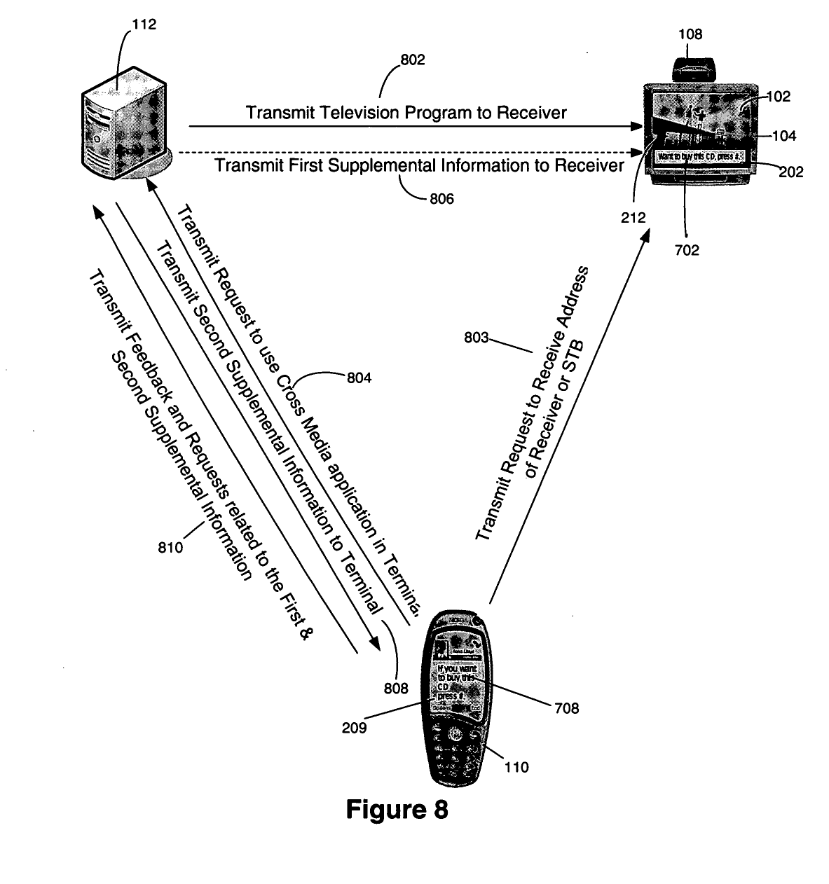

FIG. 8 illustrates a flow diagram in accordance with the configuration shown in FIG. 7 for displaying supplemental information in coordinated cross media services in accordance with an aspect of the invention. Features described in conjunction with FIGS. 2-6 are also applicable to this aspect of the invention.

Referring to FIG. 8 at step 802, cross media application server 112 transmits a television program 102 to a receiver such as television set 104 or set-top box 108. Television set 104 may display the television program on screen 212.

In step 803, the user terminal 110 transmits a request to the receiving television set 104 or set-top box 108 to receive the address of the receiving television set 104 or set-top box 108.

In step 804, user terminal 110 transmits a request to cross media application server 112 to use cross media services. This step may also include registering user terminal 110 with cross media application server 112 and transmitting the address of the receiving television set 104 or set-top box 108. The address may be requested from receiving television set 104 or set-top box 108, or it may be stored beforehand in the memory of user terminal 110. Alternatively, the address may be included in the user's account information or the registration information that is stored in the cross media application server 112. Next in step 806, cross media application server 112 determines that users are currently watching cross media capable programs on television set 104 and transmits first supplemental information 702 to the address of the television set 104 or set-top box 108 via third communication path 704 and Internet network 706 or other wireless or wireline telecommunication network or broadcasting network.

In step 808, cross media application server 112 transmits second supplemental information 708 to user terminal 110. The second supplemental information 708 may only be transmitted to those user terminals that have registered with cross media application server 112. Cross media application server 112 synchronizes the transmission of the first supplemental information 702, the second supplemental information 708 and the television program 102. In addition, cross media application server 112 substantially simultaneously transmits first and second supplemental information to the television set 104 or set-top box 108 and the user terminal 110.

User terminal 110 receives the second supplemental information 708 and may display the second supplemental information 708 on display screen 209. Finally, in step 810 user terminal 110 transmits feedback and requests related to the received information back to the cross media application server 112.

While illustrative systems and methods as described herein embodying various aspects of the present invention are shown by way of example, it will be understood, of course, that the invention is not limited to these embodiments. Modifications may be made by those skilled in the art, particularly in light of the foregoing teachings. For example, each of the elements of the aforementioned embodiments may be utilized alone or in combination with elements of the other embodiments. Also, the invention has been defined using the appended claims, however these claims are exemplary in that the invention is intended to include the elements and steps described herein in any combination or sub-combination. It will also be appreciated and understood that modifications may be made without departing from the true spirit and scope of the invention.

1. A method for providing a coordinated cross media service to a user, the method comprising:
(a) transmitting a television program to a receiver via a first communication path;
(b) transmitting first supplemental information associated with the television program to the receiver;
(c) transmitting second supplemental information associated with the television program to a terminal via a second communication path that is different than the first communication path; and
(d) registering the terminal in order to receive the second supplemental information

2. The method of claim 1, wherein the first and second supplemental information comprise identical information.

3. The method of claim 1, further comprising:
in step (d) receiving first supplemental information at the registered terminal.

4. The method of claim 1, further comprising:
(e) receiving the first supplemental information without registering to receive the first supplemental information.

5. The method of claim 1, wherein the first communication path comprises a terrestrial television broadcast.

6. The method of claim 1, wherein the first communication path comprises a cable television network.

7. The method of claim 1, wherein the second communication path comprises an Internet Protocol Datacasting (IPDC) broadcast.

8. The method of claim 1, wherein the second communication path comprises a wireless cellular communication network.

9. The method of claim 1, wherein the step of transmitting first supplemental information includes transmitting the first supplemental information over the first communication path.

10. The method of claim 1, wherein the step of transmitting first supplemental information includes transmitting the first supplemental information over a third communication path.

11. The method of claim 10, wherein the third communication path comprises an Internet.

12. The method of claim 10, wherein the third communication path comprises a telecommunications network.

13. The method of claim 1, wherein the step of transmitting first supplemental information includes using a vertical blanking interval.

14. The method of claim 1, wherein the step of transmitting first supplemental information includes using a DVB-MHP protocol.

15. The method of claim 1, further comprising:
(e) transmitting a receiving code to the terminal, the receiving code further forwarded by the terminal to the receiver, the receiving code to encrypt and decrypt the first supplemental information.

16. The method of claim 1, further comprising:
(e) receiving data from the terminal via the second communication path.

17. The method of claim 1, wherein the steps of transmitting first and second supplemental information are performed during the broadcast of the television program.

18. The method of claim 17, wherein the first supplemental information includes a prompt for user input.

19. The method of claim 18, further including a step of receiving information representing a user input made in response to the prompt via the second communication path.

20. The method of claim 1, wherein the receiver and the terminal display the supplemental information in one of the following formats: PIP, superimposed, mosaic, or window format.

21. An apparatus configured to perform the method of claim 1.

22. A computer-readable medium storing computer-executable instructions for performing the method of claim 1.

23. The method of claim 1, wherein the receiver is a television receiver.

24. The method of claim 1, wherein the receiver and the terminal are located in a single device.

25. The method of claim 24, wherein the single device comprises an IPDC terminal.

26. The method of claim 1, wherein step (b) and step (c) are performed substantially simultaneously.

27. A method for providing a coordinated cross media service to a user, the method comprising:
receiving first supplemental information associated with a television program at a terminal;
displaying the first supplemental information at the terminal;
transmitting a request to a television receiver displaying the television program to display second supplemental information associated with the television program with the displaying of the first supplemental information at the terminal.

28. The method of claim 27, wherein the terminal comprises a mobile communication terminal.

29. The method of claim 27, wherein the terminal comprises a cellular telephone.

30. The method of claim 27, wherein the television receiver and the terminal are located in a single device.

31. The method of claim 30, wherein the single device comprises an IPDC terminal.

32. The method of claim 27, further including a step of receiving a user input at the terminal, the step of transmitting a request to the television receiver being performed responsive to the user input.

33. The method of claim 27, further including steps of:
receiving a receiving code; and
forwarding the receiving code to the television receiver, the receiving code to encrypt and decrypt the second supplemental information.

34. The method of claim 27, wherein the first and second supplemental information comprise identical information.

35. The method of claim 27, further including a step of registering the terminal in order to receive the first supplemental information.

36. The method of claim 27, wherein the second supplemental information includes a prompt for user input, the method further including steps of:
receiving user input made in response to the prompt; and
transmitting information representing the user input.

37. A mobile terminal comprising a processor configured to perform the method of claim 27.

38. A computer-readable medium storing computer-readable instructions for causing a mobile terminal to perform the method of claim 27.

39. The method of claim 27, wherein the second supplemental information associated with the television program is substantially simultaneously displayed with the first supplemental information at the terminal.

40. A method for providing a coordinated cross media service to a user, the method comprising:
receiving supplemental information associated with a television program at a user terminal via a first communication path;
transmitting the supplemental information from the user terminal via a second communication path to a television receiver displaying the television program; and
displaying the supplemental information at both the user terminal and the television receiver.

41. The method of claim 40, wherein the second communication path comprises a short-range wireless path.

42. The method of claim 41, wherein the short range wireless path comprises a Bluetooth connection.

43. The method of claim 40, wherein the user terminal comprises a mobile communication terminal.

44. The method of claim 40, wherein the user terminal comprises a cellular telephone.

45. The method of claim 40, wherein the user terminal and the television receiver are located in a single device.

46. The method of claim 45, wherein the single device comprises an IPDC terminal.

47. The method of claim 40, further including a step of receiving a user input at the user terminal, the step of transmitting the supplemental information from the user terminal via a second communication path to a television receiver being performed responsive to the user input.

48. The method of claim 40, further including steps of:
receiving a receiving code; and
forwarding the receiving code to the television receiver, the receiving code to encrypt and decrypt the supplemental information.

49. The method of claim 40, further including a step of registering the user terminal in order to receive the supplemental information.

50. The method of claim 40, wherein the supplemental information includes a prompt for user input, the method further including steps of:
receiving user input made in response to the prompt; and
transmitting information representing the user input.

51. The method of claim 40, wherein the displaying of the supplemental information at both the user terminal and the television receiver is done substantially simultaneously.

52. A system for providing a coordinated cross media service to a user, the system comprising:
a television receiver for displaying a television program and supplemental information associated with the television program, the television receiver communicating through a communication path;
a user terminal for displaying the supplemental information, the user terminal receiving input from the user based on the displayed supplemental information, the user terminal communicating through a two-way communication path; and
a server for synchronizing transmission of the television program and the supplemental information, the supplemental information being displayed on both the television receiver and the user terminal, the server communicating with the user terminal through the communication path and with the user terminal through the two-way communication path.

53. The system of claim 52, wherein the user terminal registers with the server in order to receive the supplemental information.

54. The system of claim 52, wherein the communication path comprises a terrestrial television broadcast.

55. The system of claim 52, wherein the communication path comprises a cable television network.

56. The system of claim 52, wherein the two-way communication path comprises an Internet Protocol Datacasting (IPDC) broadcast.

57. The system of claim 52, wherein the two-way communication path comprises a wireless cellular communication network.

58. The system of claim 52, wherein the television receiver and the user terminal display the supplemental information in one of the following formats: PIP, superimposed, mosaic and window format.

59. The system of claim 52, wherein the supplemental information being displayed on both the television receiver and the user terminal is displayed substantially simultaneously.

60. A server for providing interactive service to a user, the server comprising:
a memory for storing supplemental information pertaining to a television program;
a first communication path for transmitting the television program and the supplemental information pertaining to the television program to at least one receiver;
a second communication path for transmitting the supplemental information pertaining to the television program to a user terminal;
wherein the supplemental information is transmitted to the at least one receiver through the first communication path and to the user terminal through the second communication path in order to display the supplemental information in the at least one receiver and the user terminal.

61. The server of claim 60, wherein the first communication path comprises a terrestrial television broadcast.

62. The server of claim 60, wherein the first communication path comprises a cable television network.

63. The server of claim 60, wherein the second communication path comprises a wireless cellular communication network.

64. The server of claim 60, wherein the supplemental information transmitted to the at least one receiver and to the user terminal is displayed substantially simultaneously.
